(19) United States
(12) Patent Application Publication
(10) Pub. No.: US 2026/0006609 A1
(43) Pub. Date: Jan. 1, 2026

(54) ENERGY EFFICIENT FREQUENCY SUBBAND SCHEDULING

(71) Applicant: QUALCOMM Incorporated, San Diego, CA (US)

(72) Inventors: Diana MAAMARI, San Diego, CA (US); Gabi SARKIS, San Diego, CA (US); Kianoush HOSSEINI, San Diego, CA (US); Sibasish DAS, San Diego, CA (US); Aria HASANZADEZONUZY, Jersey City, NJ (US)

(21) Appl. No.: 18/761,124

(22) Filed: Jul. 1, 2024

(51) Int. Cl. H04W 72/1273; H04L 5/00; H04W 72/231

(52) U.S. Cl. CPC H04W 72/1273; H04L 5/001; H04W 72/231

(57) ABSTRACT

An apparatus for wireless communication at a user equipment has one or more memories and one or more processors coupled to the memories. The processor(s) is configured to receive a first configuration of a maximum number of active component carriers. The processor(s) is also configured to receive a second configuration indicating a subset of scheduled component carriers from the maximum number of active component carriers. The receiving of the second configuration occurs in accordance with a timeline that allows the UE to process a scheduled physical downlink shared channel (PDSCH) at a reduced peak throughput corresponding to the subset of scheduled component carriers.

### FIELD OF THE DISCLOSURE

The present disclosure relates generally to wireless communications, and more specifically to efficiently scheduling only a selected subset of frequency subbands from a set of active frequency subbands.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to an apparatus. The apparatus has one or more memories and one or more processors coupled to the memories. The processor(s) is configured to receive a first configuration of a maximum number of active component carriers. The processor(s) is also configured to receive a second configuration indicating a subset of scheduled component carriers from the maximum number of active component carriers. The receiving of the second configuration occurs in accordance with a timeline that allows the UE to process a scheduled physical downlink shared channel (PDSCH) at a reduced peak throughput corresponding to the subset of scheduled component carriers.

In other aspects of the present disclosure, a method for wireless communication by a user equipment (UE) includes receiving a first configuration of a maximum number of active component carriers. The method also includes receiving a second configuration indicating a subset of scheduled component carriers from the maximum number of active component carriers. The receiving of the second configuration occurs in accordance with a timeline that allows the UE to process a scheduled physical downlink shared channel (PDSCH) at a reduced peak throughput corresponding to the subset of scheduled component carriers.

Other aspects of the present disclosure are directed to an apparatus. The apparatus has one or more memories and one or more processors coupled to the memories. The processor(s) is configured to transmit a first configuration of a maximum number of active component carriers. The processor(s) is also configured to transmit a second configuration indicating a subset of scheduled component carriers from the maximum number of active component carriers. The transmitting of the second configuration occurs in accordance with a timeline that allows a user equipment (UE) to process a scheduled physical downlink shared channel (PDSCH) at a reduced peak throughput corresponding to the subset of scheduled component carriers.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating narrowband and wideband communications, in accordance with various aspects of the present disclosure.

FIG. 5 is a state diagram illustrating operational power states of a user equipment (UE), in accordance with various aspects of the present disclosure.

FIGS. 6 and 7 are graphs illustrating power consumption over time for baseband (BB) processing, in accordance with various aspects of the present disclosure.

FIG. 8 is a block diagram illustrating a gap between physical downlink shared channel (PDSCH) transmissions, in accordance with various aspects of the present disclosure.

FIG. 9 is a block diagram illustrating flexible spectrum integration, in accordance with various aspects of the present disclosure.

FIG. 10 is a block diagram illustrating transport block (TB) scheduling and mapping with a single data channel spanning multiple subbands, in accordance with various aspects of the present disclosure.

FIG. 11 is a block diagram illustrating transport block (TB) scheduling and mapping with a multi-subband scheduling downlink control information message (DCI), in accordance with various aspects of the present disclosure.

FIGS. 12 and 13 are block diagrams illustrating energy efficient frequency subband scheduling, in accordance with various aspects of the present disclosure.

FIG. 14 is a flow diagram illustrating an example process performed, for example, by a user equipment (UE), in accordance with various aspects of the present disclosure.

FIG. 15 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including third generation (3G) and/or fourth generation (4G) technologies.

A user equipment (UE) may operate in a narrow frequency band (narrowband) or in a wide frequency band (wideband). The wide frequency band enables larger throughput than narrowband communications but increases energy consumption. Wideband communications may occur with radio frequency (RF) operation at the UE and also with baseband operation. Narrowband communications occur with baseband operation. RF operation specifies a higher clock rate and a higher supply voltage than baseband operation, thereby increasing energy consumption.

If the network informs the UE of how long the UE will be scheduled with wideband communications, the UE can set the clock frequency and voltage as needed and not necessarily at the highest setting. In other words, if the UE knows that it will not be scheduled with sustained peak throughput, the UE may not need to ramp up the clock to the highest power state.

Aspects of the present disclosure enable the network to schedule the UE with multiple component carriers (also referred to as subbands or cells) without the UE entering a high-power state, such as highest voltage corner corresponding to a maximum number of component carriers. In these aspects, the UE is informed that the UE will not have to sustain peak throughput corresponding to the maximum number of N activated component carriers. The network opportunistically schedules the UE with only x of the N activated component carriers, that is, a subset of the activated component carriers. For example, the network may activate eight component carriers, but only schedule two of the eight active component carriers. The remaining N-x (e.g., 8-2) component carriers are standby component carriers that remain active. In other words, these standby component carriers are not dormant. The UE monitors the control channel for all N activated component carriers. However, only x component carriers are scheduled. As such, the UE may perform baseband processing more slowly without sustaining the peak throughput associated with the N activated component carriers.

In further aspects, the network indicates whether these x component carriers are intra-band (e.g., collocated, adjacent, or contiguous) or inter-band (e.g., spaced apart). In still further aspects, a processing timeline for UE feedback is relaxed for each physical downlink shared channel (PDSCH) received on a scheduled component carrier. That is, feedback is not expected in accordance with a standard timeline corresponding to a wideband configuration. The network may indicate the relaxed processing timeline, in addition to indicating the number of active component carriers being scheduled. The relaxed processing timeline allows the UE to process the scheduled PDSCH at a reduced peak throughput corresponding to the peak throughput associated with the subset of component carriers from the maximum number of component carriers.

Particular aspects of the subject matter described in this disclosure can be implemented to realize one or more of the following potential advantages. In some examples, the described techniques, such as energy efficient scheduling, may enable baseband processing to operate in a favorable power state because fewer component carriers are scheduled instead of all active component carriers. Consequently, the UE may not need to operate at the highest voltage corner, thereby saving power.

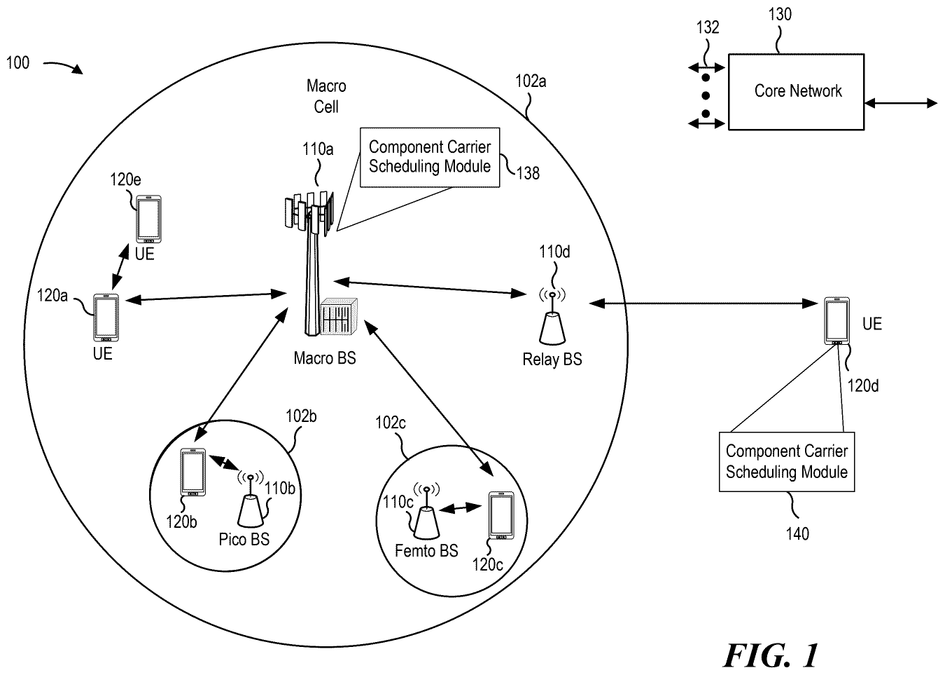

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a component carrier (CC) scheduling module 140. For brevity, only one UE 120d is shown as including the CC scheduling module 140. The CC scheduling module 140 may receive a first configuration of a maximum number of active component carriers. The CC scheduling module 140 may also receive a second configuration indicating a subset of scheduled component carriers from the maximum number of active component carriers. The receiving of the second configuration occurs in accordance with a timeline that allows the UE to process a scheduled physical downlink shared channel (PDSCH) at a reduced peak throughput corresponding to the subset of scheduled component carriers.

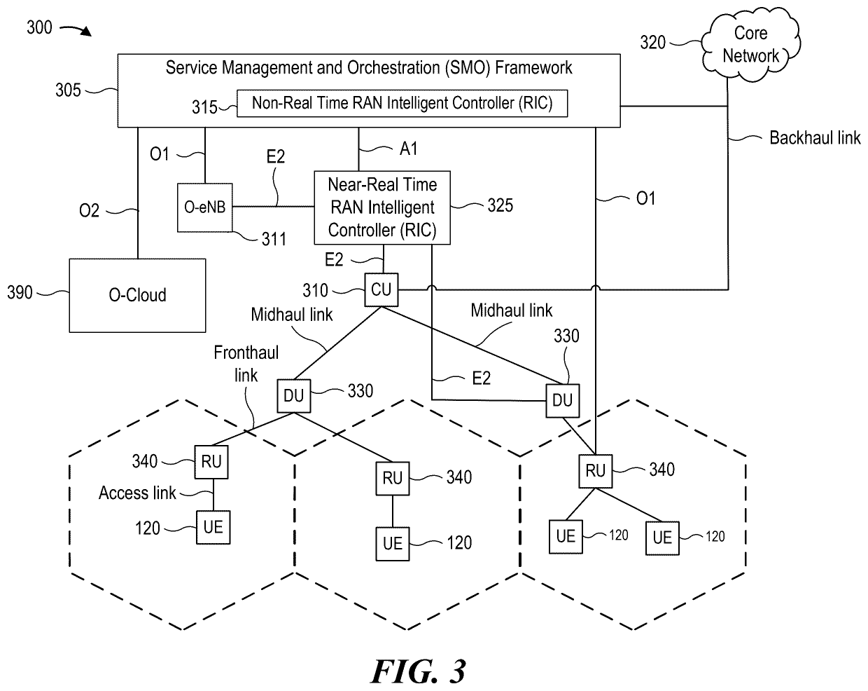

The core network 130 or the base stations 110 or any other network device (e.g., as seen in FIG. 3) may include a CC scheduling module 138. For brevity, only one base station 110a is shown as including the CC scheduling module 138. The CC scheduling module 138 may transmit a first configuration of a maximum number of active component carriers. The CC scheduling module 138 may also transmit a second configuration indicating a subset of scheduled component carriers from the maximum number of active component carriers. The transmitting of the second configuration occurs in accordance with a timeline that allows a user equipment (UE) to process a scheduled physical downlink shared channel (PDSCH) at a reduced peak throughput corresponding to the subset of scheduled component carriers.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

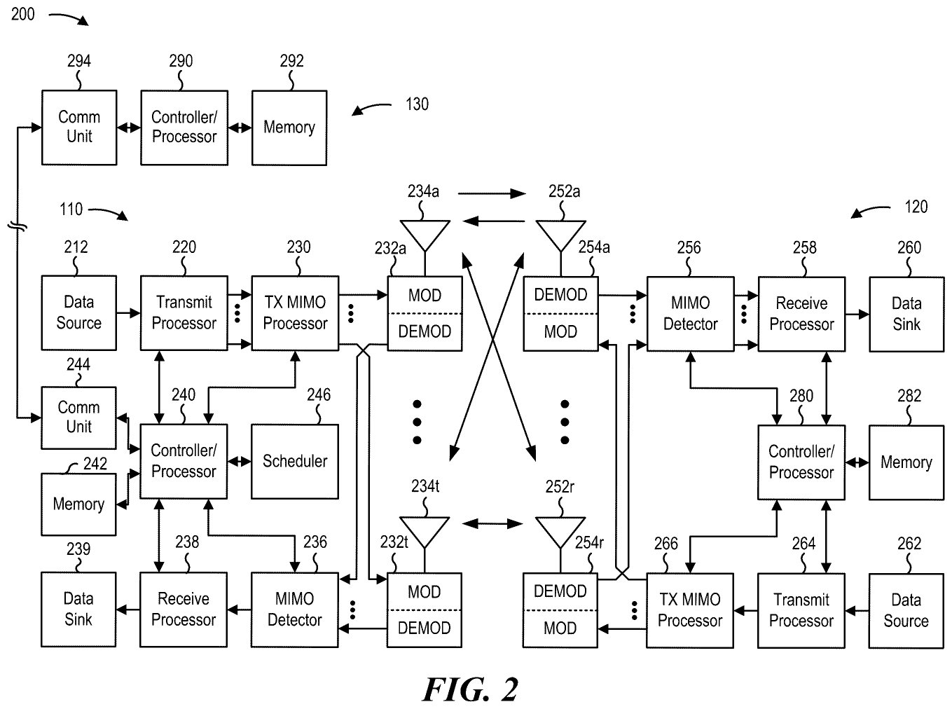

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

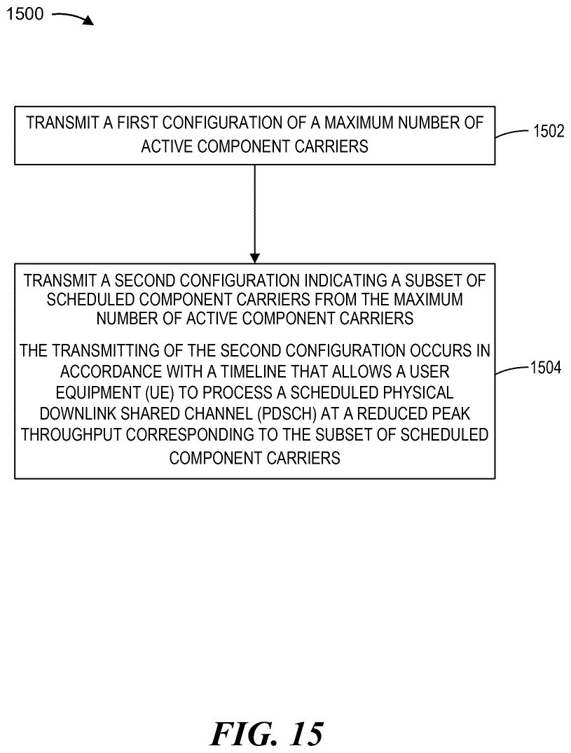

The controller/processor 240 of the base station 110, the controller/processor 280 of the UE 120, and/or any other component(s) of FIG. 2 may perform one or more techniques associated with energy efficient frequency subband scheduling, as described in more detail elsewhere. For example, the controller/processor 240 of the base station 110, the controller/processor 280 of the UE 120, and/or any other component(s) of FIG. 2 may perform or direct operations of, for example, the processes of FIGS. 15 and 16 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for reporting, and means for transmitting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more

CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

A user equipment (UE) may operate in a narrow frequency band (narrowband) or in a wide frequency band (wideband). The wide frequency band enables larger throughput than narrowband communications but increases energy consumption. Wideband communications may occur with radio frequency (RF) operation at the UE and also with baseband operation. Narrowband communications occur with baseband operation. RF operation specifies a higher clock rate and a higher supply voltage than baseband operation, thereby increasing energy consumption.

For large throughput and wideband scheduling, the UE enters a highest power state. In new radio (NR) communications, the UE moves its internal baseband clock and supply voltage to a higher power state when the UE moves to wideband scheduling. This high-power mode involves a higher clock frequency and generally higher supply voltage to support the higher clock frequency, leading to a significant increase in power consumption as well as power leakage.

If the network informs the UE of how long the UE will be scheduled with wideband communications, the UE can set the clock frequency and voltage as needed and not necessarily at the highest setting. In other words, if the UE knows it will not be scheduled with sustained peak throughput, the UE may not need to ramp up the clock to the highest power state.

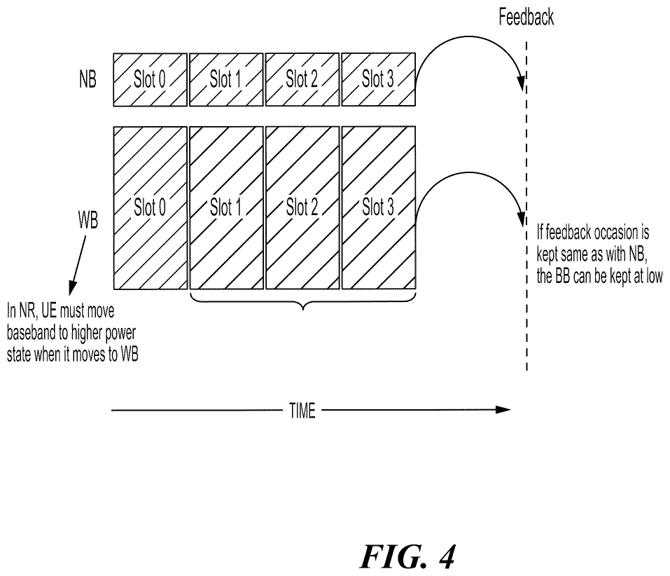

FIG. 4 is a block diagram illustrating narrowband and wideband communications, in accordance with various aspects of the present disclosure. In the example of FIG. 4, a network informs the UE that wideband (WB) scheduling only occurs for slot 0 and not for slots 1, 2, and 3. If the UE is permitted to relax a processing timeline for providing feedback to the network, baseband (BB) operations can be kept at a low-power state for the narrowband (NB) communications in slots 0-3. In the example of FIG. 4, the feedback occasion for the narrowband communications is the same as the feedback occasion for the wideband communications. For example, the UE transmits hybrid automatic repeat request (HARQ) feedback for the wideband communications at slot 0 at the same time as transmitting HARQ feedback for the narrowband communications received at slots 0, 1, 2, and 3 due to the relaxed processing timeline. Baseband operation may occur at the UE if the network guarantees to the UE that the maximum scheduled throughput will not exceed a limit. When the network indicates that the feedback timeline is relaxed, the network may also indicate that there will be gaps between physical downlink shared channel (PDSCH) transmissions, as will later be described in more detail.

In sixth generation (6G) networks, multiple operational power states map to different radio frequency (RF) and baseband (BB) assumptions. The UE may be informed, implicitly or explicitly, which operational state to use. In response, the UE sets a clock frequency and supply voltage as needed to match the expected traffic. This setting can occur with the help of a network node (e.g., gNB) transitioning the UE to a certain power state or the UE suggesting the transition and the network node responding.

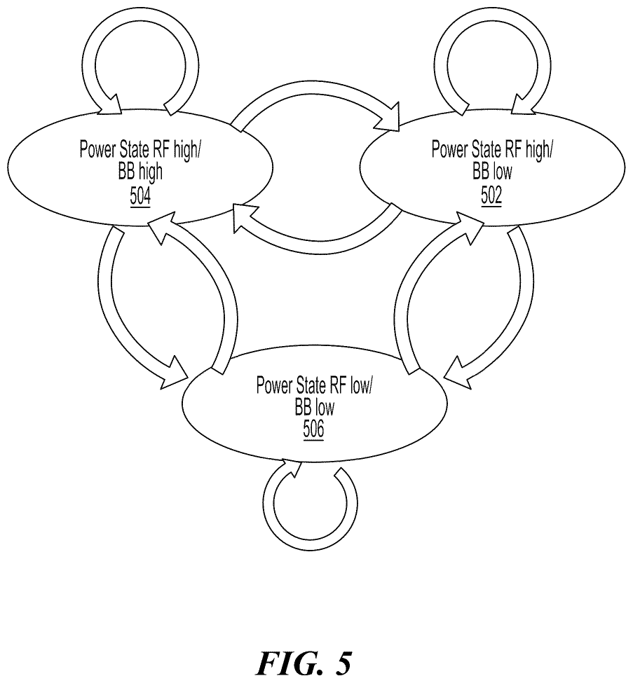

FIG. 5 is a state diagram illustrating operational power states of a user equipment (UE), in accordance with various aspects of the present disclosure. The examples of UE operational states shown in FIG. 5 are not limiting, as the states may be more granular.

UE peak throughput or peak data rate for a given number of aggregated carriers in a band or band combination is function of a number of layers, scheduled bandwidth, resource blocks (RBs), resource block groups (RBGs), resource elements (REs), modulation, coding rate, scaling factors and overhead in a certain time period, such as an OFDM symbol, slot, or subframe. According to the described techniques for reduced peak throughput or reduced data rate, a scaling factor to the OFDM symbol duration, slot, or subframe is applied. The scaling factor effectively extends the time over which the UE receives the same number of bits for the same bandwidth, RBs, RBGs, and/or REs. In some aspects, the scaling factor to the scheduled time dilates or extends the symbol time, subframe time, and/or slot time. During the extended symbol time, subframe time, and/or slot time, the UE processes a downlink scheduled at a relaxed processing timeline. In some aspects, the relaxed processing is equivalent to an extended processing timeline for wideband processing at peak throughput.

In a first power state 502, the UE is in a high radio frequency (RF) power state and low baseband (BB) power state. Example state attributes include a maximum RF bandwidth, with X number of component carriers (CCs). Other attributes include relaxed N1 processing, and a limited throughput indication, where N1 is the minimum time duration between decoding the physical downlink control channel (PDCCH) and being ready to receive the PDSCH. The limited throughput indication may be a scaling factor that scales the peak throughput, implicitly setting the clock rate or power up voltage at low. In this power state 502, the UE does not ramp up the clock rate and does not power up the clock at the highest voltage. Although the term component carrier (CC) is used, the terms subband and cell may be used interchangeably with CC.

In a second power state 504, the UE is in a high RF power state and a high baseband power state. Example state attributes include a maximum RF bandwidth, X number of CCs, tight N1 processing, and a high sustained throughput indication. The UE ramps up the clock rate and powers up the clock at the highest voltage.

In a third power state 506, the UE is in a low RF power state and a low baseband power state. Example state attributes include a minimum RF bandwidth, reduced capacity device (redcap) equivalent, relaxed N1 processing, and a limited throughput indication.

In fourth power state (not shown in FIG. 5), the UE modem is in an off state.

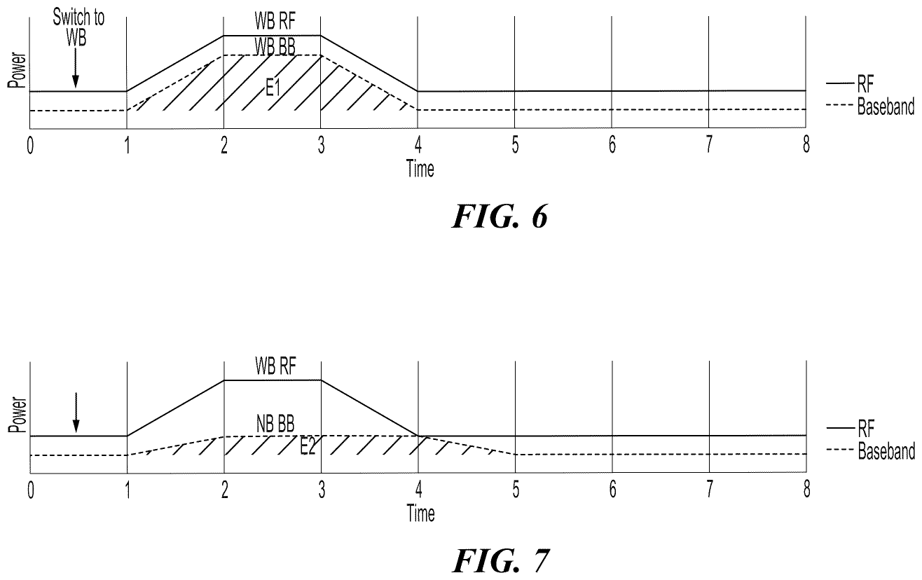

FIGS. 6 and 7 are graphs illustrating power consumption over time for baseband (BB) processing, in accordance with various aspects of the present disclosure. As seen in FIG. 6, when switching to conventional wideband scheduling, the UE power consumption E1 corresponds to wideband scheduling in baseband. With energy efficient scheduling, as seen in FIG. 7, the UE power consumption E2 is low due to the fact that the narrowband scheduling occurs in baseband. The energy gain is equivalent to E1-E2.

The UE may employ buffers for storing received data. To avoid increasing a UE buffer size, gaps are specified between PDSCH transmissions. These gaps are based on UE capability. The gaps limit the workload on a demapper of the receiver.

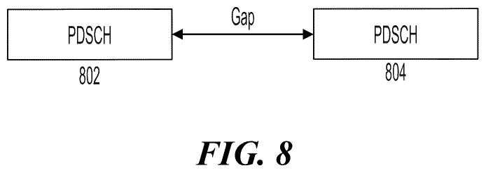

FIG. 8 is a block diagram illustrating a gap between physical downlink shared channel (PDSCH) transmissions, in accordance with various aspects of the present disclosure. In the example of FIG. 8, a first PDSCH 802 is followed by a gap, before a second PDSCH 804 transmits.

In some UE implementations, the read and write clocks are different because baseband and RF are processed differently. For example, writing to the UE buffer may occur at higher speed corresponding to a high speed digital interface output rate (e.g., at a larger bandwidth). Reading from the buffer is slower, occurring at baseband speed. UE buffer power may not adjust to reflect the differences in clock speed.

Flexible spectrum integration (FSI) is a feature that unifies the physical layer and media access control layer (PHY/MAC) across component carriers (CCs). As noted above, although the term CC is used, the terms subband and cell may be used interchangeably with CC. With flexible spectrum integration, CCs are integrated (in the same or different bands) to form a virtual carrier. As a result, a single virtual component carrier is generated for scheduling and hybrid automatic repeat request (HARQ) transmissions. That is, a single component carrier PDCCH may schedule communications for the entire virtual component carrier. Flexible spectrum integration enables smaller decoding attempts and narrow RF bandwidth for physical downlink control channel (PDCCH) transmissions. Re-transmissions may be unified across subbands (SBs) for better diversity.

Different types of transport block (TB) scheduling across aggregated subbands are possible. For example, single-TB scheduling integrates small and scattered frequency division duplex (FDD) channels as one large virtual carrier. Multi-TB scheduling employs a single component carrier PDCCH for a large aggregated bandwidth.

Bandwidth (BW) adaptation may be implemented with a bandwidth part (BWP) mechanism. Low latency adaptation may be employed when needed, depending on a UE's RF bandwidth and configured measurements.

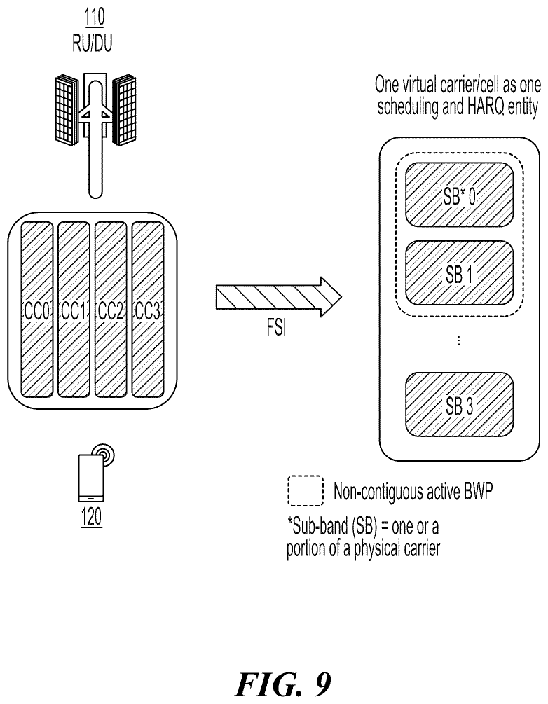

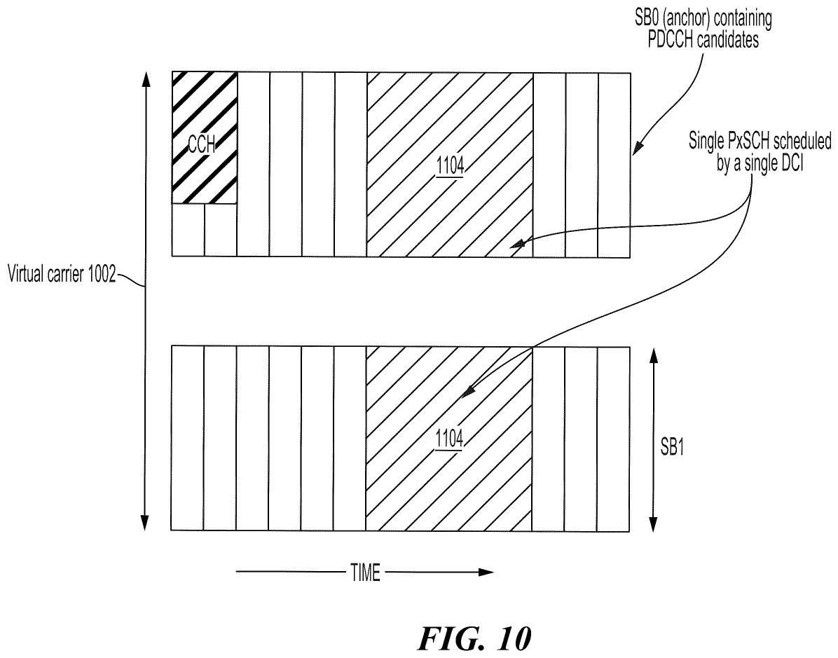

FIG. 9 is a block diagram illustrating flexible spectrum integration, in accordance with various aspects of the present disclosure. In the example of FIG. 10, a base station (e.g., RU/DU) 110 configures a UE 120 with four component carriers CC0, CC1, CC2, and CC3. Flexible spectrum integration (FSI) creates, from the active CCs, one virtual component carrier (CC) (also referred to as a virtual cell) including two non-contiguous active bandwidth parts subband zero (SB0) and subband one (SB1), where each subband is equivalent to one or a portion of a physical component carrier. Scheduling and control information is carried on an anchor subband, whereas data is transmitted on different subbands.

Flexible spectrum integration with single transport block scheduling and mapping is now described. Single transport block scheduling and mapping integrates bands with a same subcarrier spacing (SCS) and co-located deployment, although non-collocated scenarios and different SCSs are also possible.

FIG. 10 is a block diagram illustrating transport block (TB) scheduling and mapping with a single data channel spanning multiple subbands, in accordance with various aspects of the present disclosure. In the example of FIG. 10, each TB maps onto a non-contiguous BWP activated within a virtual cell. A virtual carrier 1002 includes a first subband SB0 and a second non-contiguous subband SB1. The first subband SB0 is the anchor subband and contains multiple physical downlink control channel (PDCCH) candidates, including the actual control channel (CCH). Single component carrier PDCCH blind detection occurs on the anchor subband SB0 to decode the control channel CCH. The control channel CCH includes a single downlink control information message (DCI) that schedules a single transport block 1004 for a physical downlink shared channel (PDSCH) or a physical uplink shared channel (PUSCH) that spans the non-contiguous subbands SB0, SB1. The transport block 1004 maps across the subbands SB0, SB1 with code block (CB) level interleaving, which may be favorable in a low-band spectrum with small channels. The transport block 1004 spanning different subbands SB0, SB1 may be scheduled with different link parameters, such as modulation order and rank.

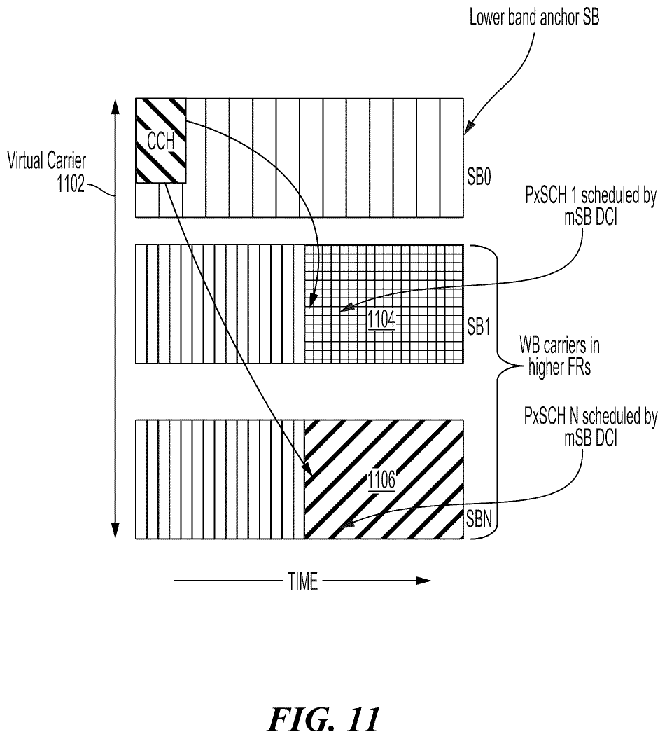

Flexible spectrum integration with multi-subband scheduling downlink control information (mSB DCI) is now described with respect to FIG. 11. FIG. 11 is a block diagram illustrating transport block (TB) scheduling and mapping with a multi-subband (mSB) scheduling downlink control information message (DCI), in accordance with various aspects of the present disclosure. In the example of FIG. 11, each transport block maps onto a single subband of a virtual carrier 1102. Multiple subbands SB0, SB1, . . . . SBN form the virtual carrier 1102. An anchor subband SB0 may be in a lower frequency band to provide more reliability. Wideband carriers correspond to subbands SB1 . . . . SBN in higher frequency ranges. The control channel (CCH) includes an mSB DCI that schedules multiple PDSCHs or PUSCHs (PxSCHs) 1104, 1106. A single component carrier PDCCH blind detection occurs to enable decoding of the CCH, including the mSB DCI scheduling multiple transport blocks on different SBs, SB1, . . . . SBN. The mSB DCI is suitable for scheduling large aggregated channel bandwidths, where cross-subband diversity is not needed. Both intra-band and inter-band scenarios are supported. Aggregation or integration with different numerologies is contemplated. Because the virtual carrier is a single HARQ entity, frequency diversity across HARQ transmissions is achieved.

While a network may activate a maximum number N of component carriers for a UE (e.g., maximum bandwidth), those N component carriers may not always be used or scheduled. This activation drives the UE to high-power states, such as the highest voltage corner, increasing UE power consumption. The network may activate the maximum number of component carriers for scheduling flexibility, coming at the cost of increased UE power consumption.

Aspects of the present disclosure enable the network to schedule the UE with multiple component carriers (also referred to as subbands or cells) without the UE entering a high-power state, such as highest voltage corner corresponding to a maximum number of component carriers. In these aspects, the UE is informed that the UE will not have to sustain peak throughput corresponding to the maximum number of N activated component carriers. The network opportunistically schedules the UE with only x of the N activated component carriers. For example, the network may activate eight component carriers, but only schedule two of the active component carriers. The remaining N-x (e.g., 8-2) component carriers are standby component carriers that remain active. In other words, these standby component carriers are not dormant. The UE monitors the control channel for all N activated component carriers. However, only x component carriers are scheduled. As such, the UE may perform baseband processing more slowly without sustaining the peak throughput associated with the N activated component carriers.

According to aspects of the present disclosure, the network indicates to the UE, early in a processing timeline, that only x (e.g., two) of the N (e.g., eight) activated component carriers will be scheduled. Thus, N−x (e.g., six) component carriers are active but on standby. More precisely, only x (e.g., two) of the N (e.g., eight) activated component carriers will be scheduled. As a result, baseband processing operates in a favorable power state because only two component carriers are scheduled instead of eight. The UE may not need to operate at the highest voltage corner, thereby saving power. Moreover, the non-scheduled component carriers are on standby, but still active, meaning the standby component carriers will not be scheduled with PDCCH or PDSCH transmissions.

In further aspects, the network indicates whether these x component carriers are intra-band (e.g., collocated, adjacent, or contiguous) or inter-band (e.g., spaced apart). In still further aspects, the processing timeline for UE feedback is relaxed for each PDSCH received on a scheduled component carrier. That is, feedback is not expected in accordance with a standard processing timeline corresponding to a wideband configuration. The network may indicate the relaxed processing timeline, in addition to indicating the number of active component carriers being scheduled. The timeline corresponds to a bandwidth part (BWP) switching timeline. It is noted that the timeline reference is with respect to the first symbol of the PDSCH. The relaxed processing timeline allows the UE to process the scheduled PDSCH at a reduced peak throughput corresponding to the peak throughput associated with the subset of component carriers from the maximum number of component carriers.

If a transport block is scheduled to span across component carriers (e.g., as seen in FIG. 10), feedback is relaxed and/or the N1 and N2 processing times are increased above minimum N1 and N2 processing times. N2 is the minimum time duration between decoding the physical downlink control channel (PDCCH) and being ready to transmit the physical uplink shared channel (PUSCH), and N1 is the minimum time duration between decoding the physical downlink control channel (PDCCH) and being ready to receive the physical uplink shared channel (PDSCH).

If a transport block is scheduled for each component carrier (e.g., as seen in FIG. 11), feedback is relaxed for each transport block. The N1 and N2 processing times for each SCS of the relevant channels for sending feedback are extended and any standardized multiplexing procedures are followed. If the component carriers have the same numerology, then the tightest N1 or N2 processing time among the component carriers is relaxed.

According to aspects of the present disclosure, the indications can be part of a DCI as long as the number of time slots between the DCI and the downlink data (e.g., k0) is much larger than zero. The DCI may transmit on an anchor subband in the flexible spectrum integration framework. If the offset k0 is not large enough, an additional offset may be introduced where the UE can monitor DCI for this indication. In this case, the DCI is also sent on the anchor SB in the FSI framework. The additional offset may not necessarily be the standard 2.5 millisecond (msec) corresponding to the BWP switching framework, as the radio frequency may not change. Thus, the additional offset from the indication may be less than the 2.5 msec specified to change clock settings. The indication can be sticky or semi-persistent for a certain period of time.

According to aspects of the present disclosure, the indication may be in the same radio resource control (RRC) message or media access control-control element (MAC-CE) that activates or deactivates component carriers. In these aspects, the RRC or MAC-CE message indicates that only x of the N activated component carriers will be utilized, while the remaining component carriers are on standby.

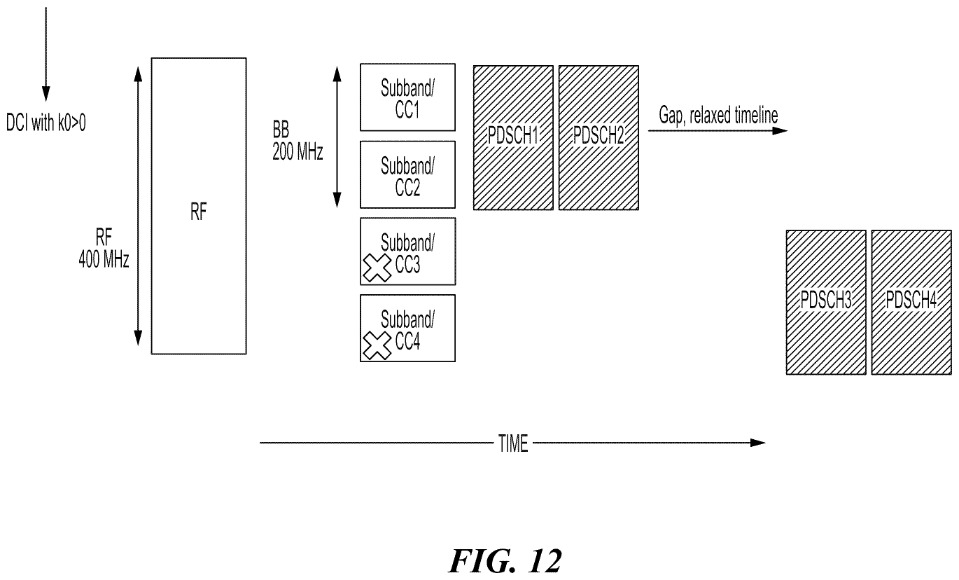

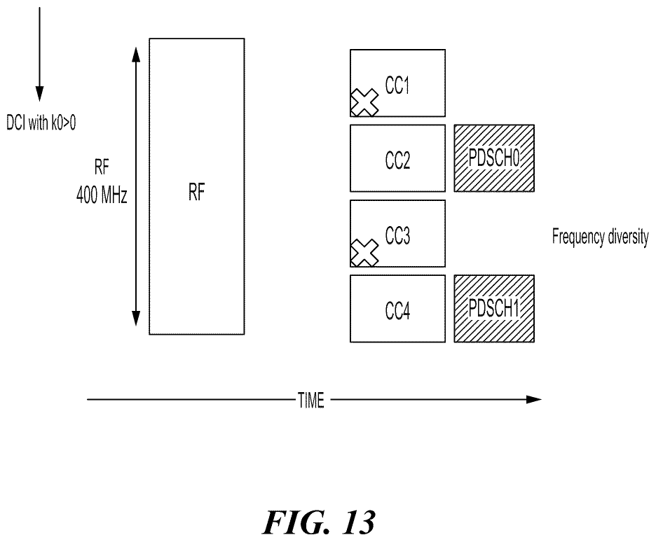

FIGS. 12 and 13 are block diagrams illustrating energy efficient frequency subband scheduling, in accordance with various aspects of the present disclosure. In the examples of FIGS. 12 and 13, the network may activate a maximum number N (4) component carriers CC1, CC2, CC3, CC4 for a UE. The network activates the maximum number of carriers for scheduling flexibility. Those four component carriers CC1, CC2, CC3, CC4 comprise 400 megahertz (MHz) of radio spectrum, but are not all scheduled. In the examples of FIGS. 12 and 13, this activation corresponds to RF operation for 400 MHZ, and may be received in a DCI more than zero timeslots before the downlink data (e.g., k0>0).

The DCI also indicates that only two component carriers will be scheduled. In the example of FIG. 12, the scheduled component carriers CC1, CC2 are contiguous. In the example of FIG. 13, the scheduled component carriers CC2, CC4 are non-contiguous. In the example of FIG. 12, the first two data transmissions PDSCH1, PDSCH2 are received, followed by a gap. After the gap, the next two data transmissions PDSCH3, PDSCH4 arrive. Because the UE is not operating in RF mode (at 400 MHz), the processing of the received data takes longer than specified for the 400 MHz timeline. Accordingly, the timeline is relaxed, permitting the feedback to be transmitted later. In the example of FIG. 13, frequency diversity is achieved for the received data PDSCH0, PDSCH1, as the data arrives in the non-contiguous component carriers CC2, CC4.

UE capability signaling will now be discussed. With energy efficient scheduling, writing to a UE buffer occurs at a higher clock frequency than reading from the UE buffer as previously explained. As such, to avoid an increase in the UE buffer size, gaps in scheduling are specified between PDSCH transmissions such that all data has been read from the buffer before the next symbol needs to be written to the buffer. The number of back-to-back PDSCH transmissions before requiring a gap depends on the UE buffer size and how much the buffer can store. Some UE implementations overprovision the buffer size to handle buffering of multiple component carrier PDSCH transmissions. The buffer size is summed over all component carriers assuming a maximum processing timeline.

According to aspects of the present disclosure, the UE reports, in a UE capability message or UE assistance information, how many component carriers can be scheduled at a same time. The UE reports the capability to store the time domain samples of the signal with more bandwidth than the baseband signal bandwidth.

In other aspects, the UE reports, in a UE capability message or UE assistance information, that the UE requires gaps in scheduling to avoid an increase in the UE buffer size. A mapping between how many component carriers are scheduled and how many gaps are needed can be based on UE capability.

Dual connectivity and dual subscriber identity module (SIM) card operations are also considered. According to aspects of the present disclosure, with dual SIMs, the UE is (almost) connected to two separate networks. Thus, signaling the number of component carriers or the requests via UE assistance information or a UE capability report from the UE is independent for each connection. The two networks can negotiate the number of component carriers over the Xn interface.

For dual connectivity, the UE buffer may be shared across a master cell group (MCG) and a secondary cell group (SCG) or may separate buffers, such as in a single-tile versus dual-tile architecture. If the buffer or memory is shared across component carriers of the MCG and SCG, then only the total number of scheduled CCs matters. According to aspects of the present disclosure, the UE reports in a UE capability message or UE assistance information how many component carriers can be scheduled out of a total number. For example, for a maximum of three out of four component carriers, the UE may report 0+3 (0 CCs for MCG, 3 CCs for SCG), 3+0 (3 CCs for MCG, 0 CCs for SCG), 1+2 (1 CC for MCG, 2 CCs for SCG), or 2+1 (2 CCs for MCG, 1 CC for SCG).

As indicated above, FIGS. 3-13 are provided as examples. Other examples may differ from what is described with respect to FIGS. 3-13.

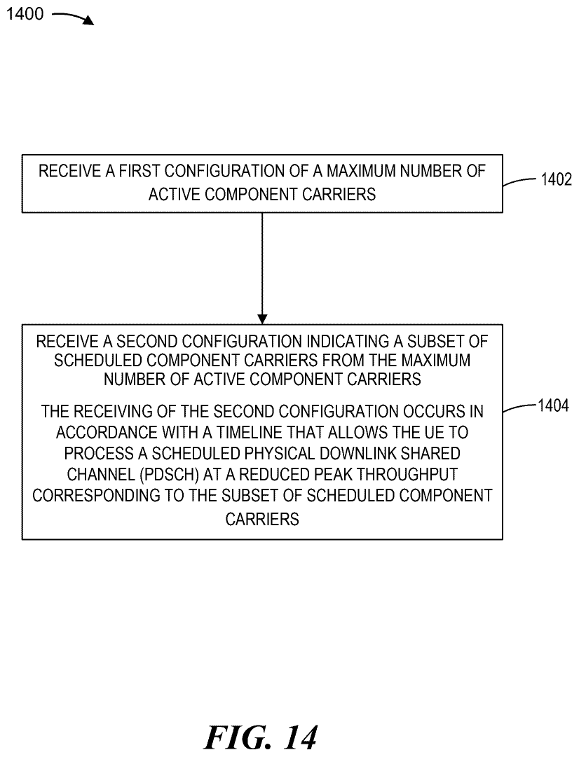

FIG. 14 is a flow diagram illustrating an example process 1400 performed, for example, by a user equipment (UE), in accordance with various aspects of the present disclosure. The example process 1400 is an example of efficiently scheduling only a selected subset of frequency subbands from a set of active frequency subbands by a user equipment. The operations of the process 1400 may be implemented by a UE 120.

At block 1402, the user equipment (UE) receives a first configuration of a maximum number of active component carriers. For example, the UE (e.g., using the antenna 252, DEMOD/MOD 254, MIMO detector 256, receive processor 258, controller/processor 280, memory 282, and/or the like) may receive the first configuration.

At block 1404, the user equipment (UE) receives a second configuration indicating a subset of scheduled component carriers from the maximum number of active component carriers. The receiving of the second configuration occurs in accordance with a timeline that allows the UE to process a scheduled physical downlink shared channel (PDSCH) at a reduced peak throughput corresponding to the subset of scheduled component carriers. For example, the UE (e.g., using the antenna 252, DEMOD/MOD 254, MIMO detector 256, receive processor 258, controller/processor 280, memory 282, and/or the like) may receive the second configuration. In some aspects, the second configuration indicates whether the subset of scheduled component carriers are intra-band component carriers or inter-band component carriers. The second configuration may indicates a relaxed processing timeline for providing feedback for the subset of scheduled component carriers if the timeline is less than a bandwidth part (BWP) switching timeline. The second configuration may be received via a downlink control information (DCI) message, a radio resource control (RRC) message or a media access control-control element (MAC-CE) message that activates or deactivates selected component carriers of the maximum number of active component carriers.

FIG. 15 is a flow diagram illustrating an example process 1500 performed, for example, by a network device, in accordance with various aspects of the present disclosure. The example process 1500 is an example of efficiently scheduling only a selected subset of frequency subbands from a set of active frequency subbands by a network device. The operations of the process 1500 may be implemented by a base station 110.

At block 1502, the base station transmits a first configuration of a maximum number of active component carriers. For example, the base station (e.g., using the antenna 234, MOD/DEMOD 232, TX MIMO processor 230, transmit processor 220, controller/processor 240, memory 242, and/or the like) may transmit the first configuration.

At block 1504, the base station transmits a second configuration indicating a subset of scheduled component carriers from the maximum number of active component carriers. The transmitting of the second configuration occurs in accordance with a timeline that allows a user equipment (UE) to process a scheduled physical downlink shared channel (PDSCH) at a reduced peak throughput corresponding to the subset of scheduled component carriers. For example, the base station (e.g., using the antenna 234, MOD/DEMOD 232, TX MIMO processor 230, transmit processor 220, controller/processor 240, memory 242, and/or the like) may transmit the second configuration. In some aspects, the second configuration indicates whether the subset of scheduled component carriers are intra-band component carriers or inter-band component carriers. The second configuration may indicates a relaxed processing timeline for providing feedback for the subset of scheduled component carriers if the timeline is less than a bandwidth part (BWP) switching timeline. The second configuration may be received via a downlink control information (DCI) message, a radio resource control (RRC) message or a media access control-control element (MAC-CE) message that activates or deactivates selected component carriers of the maximum number of active component carriers.

### Example Aspects

Aspect 1: An apparatus for wireless communication at a user equipment (UE), comprising: at least one memory; and at least one processor coupled to the at least one memory, the at least one processor configured: to receive a first configuration of a maximum number of active component carriers; and to receive a second configuration indicating a subset of scheduled component carriers from the maximum number of active component carriers, the receiving of the second configuration occurring in accordance with a timeline that allows the UE to process a scheduled physical downlink shared channel (PDSCH) at a reduced peak throughput corresponding to the subset of scheduled component carriers.

Aspect 2: The apparatus of Aspect 1, in which the second configuration indicates whether the subset of scheduled component carriers are intra-band component carriers or inter-band component carriers.

Aspect 3: The apparatus of Aspect 1, in which the second configuration indicates a relaxed processing timeline for providing feedback for the subset of scheduled component carriers if the timeline is less than a bandwidth part (BWP) switching timeline.

Aspect 4: The apparatus of any of the preceding Aspects, in which the second configuration comprises a downlink control information (DCI) message.

Aspect 5: The apparatus of any of the Aspects 1-3, in which the second configuration comprises a radio resource control (RRC) or a media access control-control element (MAC-CE) message that activates or deactivates selected component carriers of the maximum number of active component carriers.

Aspect 6: The apparatus of any of the preceding Aspects, in which the at least one processor is further configured to report a maximum number of simultaneously supported scheduled component carriers, based on a UE buffer size.

Aspect 7: The apparatus of any of the preceding Aspects, in which the at least one processor is further configured to report a scheduling gap requirement, based on a UE buffer size.

Aspect 8: A method of wireless communication by a user equipment (UE), comprising: receiving a first configuration of a maximum number of active component carriers; and receiving a second configuration indicating a subset of scheduled component carriers from the maximum number of active component carriers, the receiving of the second configuration occurring in accordance with a timeline that allows the UE to process a scheduled physical downlink shared channel (PDSCH) at a reduced peak throughput corresponding to the subset of scheduled component carriers.

Aspect 9: The method of Aspect 8, in which the second configuration indicates whether the subset of scheduled component carriers are intra-band component carriers or inter-band component carriers.

Aspect 10: The method of Aspect 8, in which the second configuration indicates a relaxed processing timeline for providing feedback for the subset of scheduled component carriers if the timeline is less than a bandwidth part (BWP) switching timeline.

Aspect 11: The method of any of the Aspects 8-10, in which the second configuration comprises a downlink control information (DCI) message.

Aspect 12: The method of any of the Aspects 8-10, in which the second configuration comprises a radio resource control (RRC) or a media access control-control element (MAC-CE) message that activates or deactivates selected component carriers of the maximum number of active component carriers.

Aspect 13: The method of any of the Aspects 8-12, further comprising reporting a maximum number of simultaneously supported scheduled component carriers, based on a UE buffer size.

Aspect 14: The method of any of the Aspects 8-13, further comprising reporting a scheduling gap requirement, based on a UE buffer size.

Aspect 15: An apparatus for wireless communication at a network device, comprising: transmitting a first configuration of a maximum number of active component carriers; and transmitting a second configuration indicating a subset of scheduled component carriers from the maximum number of active component carriers, the transmitting of the second configuration occurring in accordance with a timeline that allows a user equipment (UE) to process a scheduled physical downlink shared channel (PDSCH) at a reduced peak throughput corresponding to the subset of scheduled component carriers.

Aspect 16: The apparatus of Aspect 15, in which the second configuration indicates whether the subset of scheduled component carriers are intra-band component carriers or inter-band component carriers.

Aspect 17: The apparatus of Aspect 15, in which the second configuration indicates a relaxed processing timeline for providing feedback for the subset of scheduled component carriers if the timeline is less than a bandwidth part (BWP) switching timeline.

Aspect 18: The apparatus of any of the Aspects 15-17, in which the second configuration comprises a downlink control information (DCI) message.

Aspect 19: The apparatus of any of the Aspects 15-17, in which the second configuration comprises a radio resource control (RRC) or a media access control-control element (MAC-CE) message that activates or deactivates selected component carriers of the maximum number of active component carriers.

Aspect 20: The apparatus of any of the Aspects 15-19, further comprising receiving a report of a maximum number of simultaneously supported scheduled component carriers, based on a UE buffer size.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication at a user equipment (UE), comprising:
at least one memory; and
at least one processor coupled to the at least one memory, the at least one processor configured:
to receive a first configuration of a maximum number of active component carriers; and
to receive a second configuration indicating a subset of scheduled component carriers from the maximum number of active component carriers, the receiving of the second configuration occurring in accordance with a timeline that allows the UE to process a scheduled physical downlink shared channel (PDSCH) at a reduced peak throughput corresponding to the subset of scheduled component carriers.

2. The apparatus of claim 1, in which the second configuration indicates whether the subset of scheduled component carriers are intra-band component carriers or inter-band component carriers.

3. The apparatus of claim 1, in which the second configuration indicates a relaxed processing timeline for providing feedback for the subset of scheduled component carriers if the timeline is less than a bandwidth part (BWP) switching timeline.

4. The apparatus of claim 1, in which the second configuration comprises a downlink control information (DCI) message.

5. The apparatus of claim 1, in which the second configuration comprises a radio resource control (RRC) message or a media access control-control element (MAC-CE) message that activates or deactivates selected component carriers of the maximum number of active component carriers.

6. The apparatus of claim 1, in which the at least one processor is further configured to report a maximum number of simultaneously supported scheduled component carriers, based on a UE buffer size.

7. The apparatus of claim 1, in which the at least one processor is further configured to report a scheduling gap requirement, based on a UE buffer size.

8. A method of wireless communication by a user equipment (UE), comprising:
receiving a first configuration of a maximum number of active component carriers; and
receiving a second configuration indicating a subset of scheduled component carriers from the maximum number of active component carriers, the receiving of the second configuration occurring in accordance with a timeline that allows the UE to process a scheduled physical downlink shared channel (PDSCH) at a reduced peak throughput corresponding to the subset of scheduled component carriers.

9. The method of claim 8, in which the second configuration indicates whether the subset of scheduled component carriers are intra-band component carriers or inter-band component carriers.

10. The method of claim 8, in which the second configuration indicates a relaxed processing timeline for providing feedback for the subset of scheduled component carriers if the timeline is less than a bandwidth part (BWP) switching timeline.

11. The method of claim 8, in which the second configuration comprises a downlink control information (DCI) message.

12. The method of claim 8, in which the second configuration comprises a radio resource control (RRC) message or a media access control-control element (MAC-CE) message that activates or deactivates selected component carriers of the maximum number of active component carriers.

13. The method of claim 8, further comprising reporting a maximum number of simultaneously supported scheduled component carriers, based on a UE buffer size.

14. The method of claim 8, further comprising reporting a scheduling gap requirement, based on a UE buffer size.

15. An apparatus for wireless communication at a network device, comprising:
transmitting a first configuration of a maximum number of active component carriers; and
transmitting a second configuration indicating a subset of scheduled component carriers from the maximum number of active component carriers, the transmitting of the second configuration occurring in accordance with a timeline that allows a user equipment (UE) to process a scheduled physical downlink shared channel (PDSCH) at a reduced peak throughput corresponding to the subset of scheduled component carriers.

16. The apparatus of claim 15, in which the second configuration indicates whether the subset of scheduled component carriers are intra-band component carriers or inter-band component carriers.

17. The apparatus of claim 15, in which the second configuration indicates a relaxed processing timeline for providing feedback for the subset of scheduled component carriers if the timeline is less than a bandwidth part (BWP) switching timeline.

18. The apparatus of claim 15, in which the second configuration comprises a downlink control information (DCI) message.

19. The apparatus of claim 15, in which the second configuration comprises a radio resource control (RRC) message or a media access control-control element (MAC-CE) message that activates or deactivates selected component carriers of the maximum number of active component carriers.

20. The apparatus of claim 15, further comprising receiving a report of a maximum number of simultaneously supported scheduled component carriers, based on a UE buffer size.
